(19) United States
(12) Patent Application Publication
(10) Pub. No.: US 2007/0069009 A1
(43) Pub. Date: Mar. 29, 2007

(54) Magnetic Stripe Card Medium for Pharmacy Input of Patient Third Party, Medical and Demographic Information

(75) Inventors: Peter Richard DeVuyst, Niceville, FL (US); Peter Richard DeVuyst, Niceville, FL (US)

Correspondence Address: PETER RICHARD DEVAYST, 4308 HIDDEN LAKES DR., NICEVILLE, FL, 32578, US

(73) Assignee: Peter Richard DeVuyst, Niceville, FL (US)

(21) Appl. No.: 11/162,886

(22) Filed: Sep. 27, 2005

(51) Int. Cl. G06K 5/00

(52) U.S. Cl. 235/380

(57) ABSTRACT

Current hardware, along with customized copyrighted software, can be utilized to enhance efficiency of information processing by pharmacy personnel and as a byproduct, bring third party payers into compliance with statutory laws.

By utilizing current hardware technology and specifically written copyrighted software, this application will enhance the ability of pharmacists to enter third party information for specific patient records. The intent is to remove the manual input method currently in use in community pharmacies; a method that is laborious and often error prone.

Pertinent patient information includes, but is not limited to: cardholder name (first, middle and last), patient name (first, middle and last), cardholder identification number (utilizing alphanumeric characters), relationship code, date of birth (both patient and cardholder), group expression utilizing alphanumeric characters) and third party identifier.

Optional information to be included is allergy information, medication intolerances and chronic disease state information.

This system will be adapted to work with existing pharmacy systems, by use of copyrighted computer software, enabling the magnetic card reading ability to be customized to specific pharmacy computer systems in use.

The inaugural system utilizes MSR206 (product of UICUSA), a reader/writer, in order to make available pertinent insurance information scanned from an encoded magnetic stripe card and submitted into the appropriate fields of the user's pharmacy computer system. The computer is in communication with the card reader and writer, where appropriate, by either a serial or USB port.

For read only functions, a MSR210D Magnetic Stripe Card Reader (product of UICUSA) is utilized.

Compatible magnetic stripe card readers and/or writers may be substituted.

High and low coercivity magnetic stripe cards are utilized in this application, in accordance with the dictates of the computer systems involved.

What is claimed is:

1. Reduced time needed for data entry by medical personnel.

2. Reduced errors in information submission.

3. Enhancement of health care delivery.

4. Elimination of problems with non-uniformity of pertinent information currently provided by third party payers.
